(19) United States
(12) Patent Application Publication
(10) Pub. No.: US 2002/0116368 A1
(43) Pub. Date: Aug. 22, 2002

(54) Personal digital assistant device, service information distribution device, control method, computer-readable storing medium and computer program

(75) Inventor: Shinichi Matsumoto, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/075,399

(22) Filed: Feb. 15, 2002

(30) Foreign Application Priority Data
Feb. 20, 2001 (JP) 2001-044200

(51) Int. Cl. G06F 7/00; G06F 17/30

(52) U.S. Cl. 707/1

(57) ABSTRACT

The present invention is devised to present various services to visitors in a place where many visitors gather. In the present invention, use information such as positional information of a position where a personal digital assistant device of the user is sent intermittently from the personal digital assistant device to a service information distribution device, and the service information distribution device stores the intermittently received use information in a history database as history data, and service information to be distributed is selected on the basis of the use information stored in the history database and the selected service information is distributed to the personal digital assistant device.

### BACKGROUND OF THE INVENTION

1. Field of the Invention

The present invention relates to a working system in which information is transferred between a personal digital assistant device (PDA) and a service information distribution device having a database for storing personal information and positional information so that various services are presented to the user of the personal digital assistant device, on the basis of the database.

2. Related Background Art

In the past, in places which have a great ground area or floor and where many visitors gather, such as recreation grounds, exhibition grounds, theme parks, hotels and department stores, various services such as various events, attractions and sales of goods and/or foods and drinks have been presented to the visitors.

In such places, when the visitor wants to receive such service and when the visitor tries to know information regarding the services, the user must move to the pace where the service is performed. Incidentally, in some places, a method in which various informations regarding management are displayed on display boards in the grounds and/or halls and are informed by voice announce has been adopted.

Further, some mobile telephones, PHS (personal handyphone system) telephones or portable equipments having a wireless communication function are provided with a function capable of recognizing or detecting positional information for specifying a place where the personal digital assistant device thereof is located.

As methods for utilizing such a positional information detecting function, an application example in which the position of the personal digital assistant device is displayed on a screen in an overlapped relationship with map data by detecting a place where the person possessing the personal digital assistant device exists in synchronous with the map data and an application example in which the user can receive useful information regarding a place where the user exists have been put to a practical use.

By the way, as a method for utilizing such a positional information detecting function, it is general that the service is fundamentally presented by the organizer one-sidedly.

However, in places where many visitors gather, among various information regarding services presented by the organizer, in order to know information (such as opening of event, time service and grasping of congestion condition) which is successively changed as time is lapsed timely, since the user must always be waiting at the place where the service is presented, useless time will be spent.

Further, when guidance on the display board is utilized, the user must purposely go the place where the display board is installed. In addition, when guidance of voice announce is utilized, the user must always pay attention not to miss the announce voice, which results in the user's inconvenience.

### SUMMARY OF THE INVENTION

The present invention is made in consideration of the above above-mentioned problems, and an object of the present invention is to permit the visitor to efficiently utilize various services presented by the organizer in a place where many visitors gather.

A personal digital assistant device according to the present invention is characterized in that usable information for the user using the personal digital assistant device is intermittently transmitted so as to be added to a history database managed by a service information distribution device, and the user receives, from the service information distribution device, service information selected by the service information distribution device on the basis of history of the usable information stored in the history database.

Further, a service information distribution device according to the present invention is characterized in that the usable information for the user is intermittently received from the personal digital assistant device, and the received usable information is stored in the history database as history data, and the service information to be distributed to the personal digital assistant device is selected on the basis of the history of the usable information stored in the history database, and the selected service information is transmitted to the personal digital assistant device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constituted a part of the specification, illustrate embodiments of the invention and, together with the description, serve to explain the principles of the invention.

FIG. 1 is a system block diagram showing a schematic construction including a personal digital assistant device and a server system, according to a first embodiment of the present invention;

FIG. 2 is a block diagram showing a schematic construction of the personal digital assistant device according to the first embodiment of the present invention;

FIG. 3 is a flow chart for explaining a processing procedure when data is actively transmitted to the personal digital assistant device, in processing of the server system according to the first embodiment of the present invention;

FIG. 4 is a flow chart for explaining a processing procedure executed with respect to received data from the personal digital assistant device, in processing of the server system according to the first embodiment of the present invention;

FIG. 5 is a flow chart showing detailed processing for adding received positional information data to a personal information database portion of the server system according to the first embodiment of the present invention;

FIG. 6 is a view showing a data structure of the personal information data for a certain personal digital assistant device, in the personal information database portion of the server system according to the first embodiment of the present invention;

FIG. 7 is a flow chart for explaining a processing procedure for requesting a service to the server system, in processing of the personal digital assistant device according to the first embodiment of the present invention;

FIG. 8 is a flow chart for explaining a processing procedure when data from the server system is received, in processing of the personal digital assistant device according to the first embodiment of the present invention;

FIG. 9 is a view showing an example of a display screen for message displayed in a display portion when various informations are received by a portable information terminal, according to the first embodiment of the present invention;

FIG. 10 is a flow chart for explaining a processing procedure when data is actively transmitted to a personal digital assistant device, in processing of a server system according to a second embodiment of the present invention;

FIG. 11 is a flow chart for explaining a processing procedure when data is received from the personal digital assistant device, in processing of the server system according to the second embodiment of the present invention;

FIG. 12 is a flow chart for explaining calculation and sending processing of congestion information in detail, according to the second embodiment of the present invention;

FIG. 13 is a view showing a data structure of a block information database according to the second embodiment of the present invention;

FIG. 14 is a flow chart for explaining a processing procedure when a service is requested to the server system, in processing of the personal digital assistant device according to the second embodiment of the present invention;

FIG. 15 is a view showing an example of a display screen for congestion degree information displayed on a display portion of the personal digital assistant device according to the second embodiment of the present invention;

FIG. 16 is a view showing a data structure of a database totalized with reference to personal database, according to the second embodiment of the present invention;

FIG. 17 is a view showing a data structure of a database totalized with reference to personal databases, according to a third embodiment of the present invention;

FIG. 18 is a flow chart showing a detailed procedure of sending processing of article information, according to the third embodiment of the present invention;

FIG. 19 is a flow chart for explaining contents of processings including in other processings in detail among processings executed with respect to data received from a personal digital assistant device by means of a server system according to a fourth embodiment of the present invention;

FIG. 20 is a view showing an example of a screen on which a search result is displayed, in a display portion of the personal digital assistant device by which a search service is requested, according to the fourth embodiment of the present invention;

FIG. 21 is a system block diagram showing a schematic construction including a personal digital assistant device and a server system, according to a fifth embodiment of the present invention; and

FIG. 22 is a view showing a flow of management of a system utilizing a personal digital assistant device and a server system, according to a sixth embodiment of the present invention.

### DESCRIPTION OF THE PREFERRED EMBODIMENTS

Now, embodiments of a personal digital assistant device, a service information distribution device, a controlling method, a computer-readable storing medium and a computer program according to the present invention will be explained with reference to the accompanying drawings.

<First Embodiment>

In a first embodiment of the present invention, an embodiment of a system in which personal digital assistant devices and a server system are incorporated into a local area PHS network only effective to a specific area, and distribution of information, and request and execution of a service are effected, and positional information of the personal digital assistant device is associated with a database will be explained.

Further, in the first embodiment, an application example in which the present invention is carried out in a place where articles are mainly sold and bought, such as a department store and a shopping center will be fully explained.

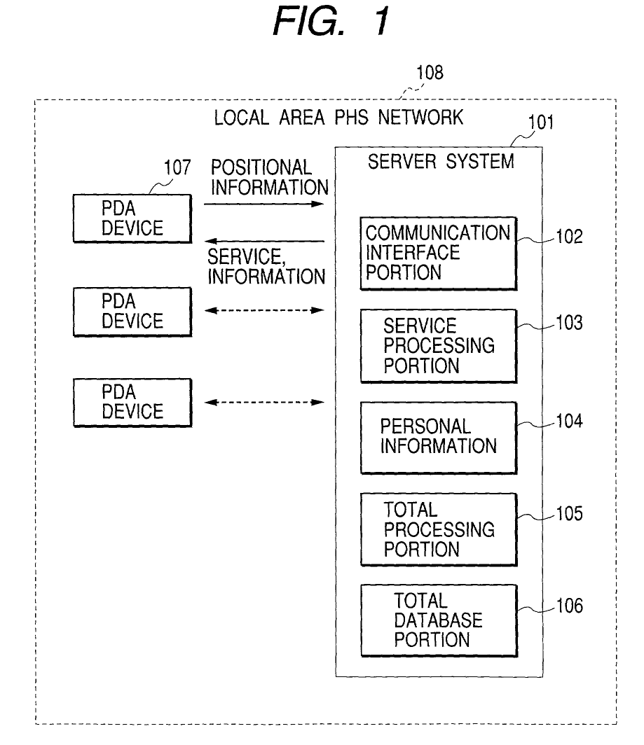

FIG. 1 is a system block diagram showing a schematic construction including a personal digital assistant device and a server system, according to the first embodiment of the present invention.

In FIG. 1, a server system 101 serves to effect storage, management and service presentation of data. The server system 101 includes a communication interface portion 102, a service processing portion 103, a personal information database portion 104, and a total processing portion 105, and access to personal digital assistant devices 107 is possible.

The communication interface portion 102 of the server system 101 serves as an interface for communication with respect to the personal digital assistant devices 107, and, in the illustrated embodiment, an interface using a local area PHS circuit effective to a specific area is used. Through the interface, sending and receiving of positional information data, information distribution data and other digital data are effected.

Further, the service processing portion 103 of the server system 101 is a portion for performing processing for distributing useful information and guidance to the personal digital assistant devices 107, processing for executing various services requested from the personal digital assistant devices 107 and processing for acquiring positional informations of the personal digital assistant devices 107, and, for example, these processing operations include distribution of information (such as opening of event, time service and grasping of congestion condition) which is successively changed as time is lapsed, execution of request for purchasing and reservation of the article, sending of request data for acquiring positional information, accounting processing for pay service and the like.

When the useful information or guidance is distributed to the personal digital assistant device 107, the service processing portion 103 serves to distribute personal information (basic information and various history data) regarding the user of the personal digital assistant device and stored in the personal information database portion 104 and to select and distribute such information or guidance on the basis of a total processing result stored in the total database portion 106.

Further, the personal information database portion 104 of the server system 101 serves to store and manage personal informations regarding the users of the personal digital assistant devices 107 for every users, and the personal information may include history data of services used during the usage of the personal digital assistant device 107, history data of detected positional information and total data of charges accounted when the pay service is used or when the article is purchased, as well as basic data such as name, address, age and sex distinction of the user.

Further, the total processing portion 105 of the server system 101 is a portion for performing total processing in accordance with use purpose with reference to the personal information data stored in the personal information database portion 104.

For example, the total processing includes processing operations for performing calculation of a block where many visitors gather and analysis of a flow of persons with reference to the history data of positional information, performing totaling of services which are used by many users and calculation of time period of such services with reference to the service utilizing history data, and performing calculation an average accounting charge per one user. Further, the total database portion 106 of the server system 101 is an area for arranging the total result processed in the total processing portion 105 as a database and storing such total result.

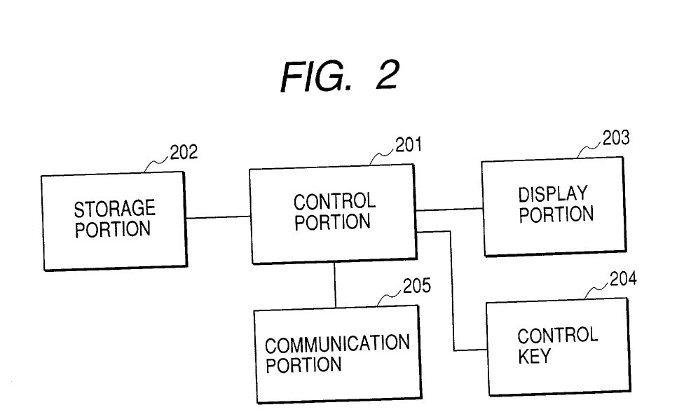

Each personal digital assistant device 107 has a communication function with the server system 101 and can perform requesting for various services and sending of positional information data to the server system 101 and perform receiving of information distributed from the server system 101. A detailed construction of the personal digital assistant device 107 will be explained in connection with FIG. 2.

The reference numeral 108 denotes a range of the local area PHS network only effective to the specific area, and the server system 101 and the personal digital assistant devices 107 are all used in this effective area.

Next, a schematic construction of the personal digital assistant device 107 used in the first embodiment of the present invention will be explained with reference to a block shown in FIG. 2.

In FIG. 2, a control portion 201 serves to effect control of the portable information terminal (personal digital assistant device). A storing portion 202, a display portion 203, a control key 204, and a communication portion 205 are connected to the control portion so that they are controlled by the control portion 201.

Further, in the control portion 201, processing for displaying information received by the communication portion 205 on the display portion 203, processing for acquiring the positional information in accordance with the sending request for the positional information and for sending it from the communication portion 205 and processing for executing application corresponding to the service such as article purchasing, reservation or charge displaying are effected.

The storing portion 202 includes a flash memory for reserving information data received by the communication portion 205, a ROM (read-only memory) for storing a control program executed in the control portion 201, and a RAM (random access memory) used as a work area by the control program.

The display portion 203 serves to display character information and/or image information and includes a TFT color LCDs and controllers and drivers therefor.

The key portion 204 is operated by the operator. When the operator operates the key portion, the application is executed in the control portion 201 to perform switching of mode and selection and designation on an application display screen.

The communication portion 205 serves to perform data communication. Through this communication portion, information data and command for control can be sent and received with respect to external communication equipments. In the illustrated embodiment, radio communication such as PHS is supposed as communication means, and thus, the communication portion includes an antenna and an RF module.

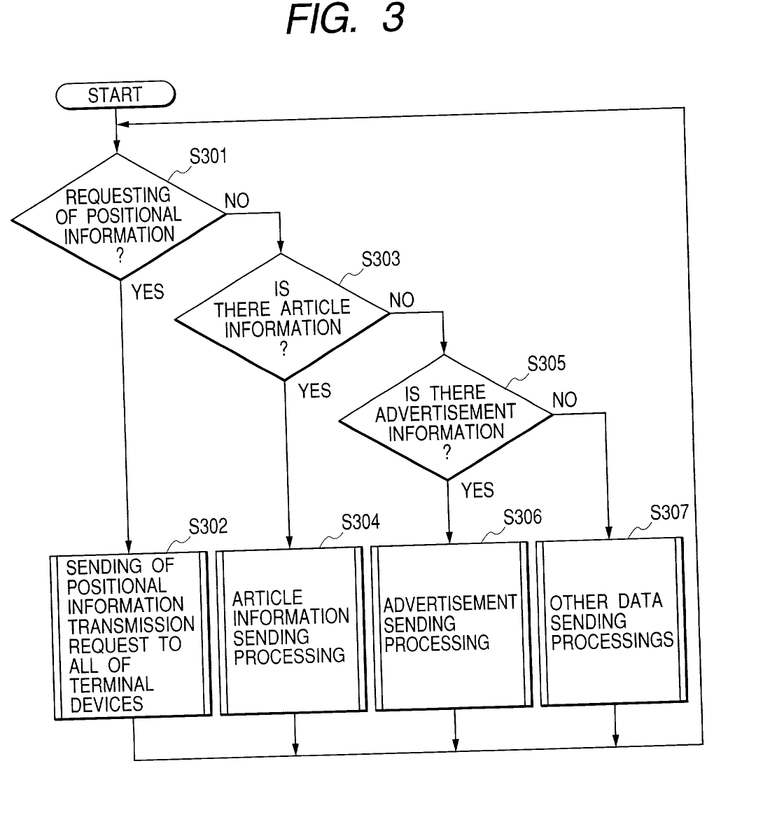

Now, a control processing procedure according to the first embodiment will be explained with reference to flow charts shown in FIG. 3 and so on.

FIG. 3 is a flow chart for explaining a processing procedure when data is actively transmitted to the personal digital assistant device 107, in processing of the server system 101.

In FIG. 3, in a step S301, processing for checking whether there is a timing for requesting the positional information is effected. The requesting of positional information is executed at a predetermined time interval with reference to a clock provided in the server system 101 to acquire the positional information of the personal digital assistant device 107 periodically.

Here, if there is the timing for requesting the positional information, in a step S302, in order to acquire the positional information of the personal digital assistant device 107 used in the ground, sending request data regarding positional information is sent to all of the personal digital assistant devices 107. Then, the program is returned to a processing waiting loop again.

Further, in the step S301, if there is no request for the positional information, the program goes to a step S303, where processing for checking whether there is a timing for sending the article information is executed.

As the timing for sending the article information, for example, a case where information regarding time service or meal is sent at a previously programmed timing or a case where such information is sent irregularly by manipulating the server system 101 by the operator is considered.

If there is the timing for sending the article information, in a step S304, processing for sending the information regarding the article to all of the personal digital assistant devices 107 is executed. Then, the program is returned to the processing waiting loop again.

On the other hand, in the step S303, if there is no timing for sending the article information, the program goes to a step S305, where processing for checking whether there is a timing for sending advertisement information is executed.

The sending of the advertisement information is previously programmed in the server system 101 by request from enterprises and is sent to a programmed timing. If there is the timing for advertisement information, in a step S306, the processing for sending the advertisement information to all of the personal digital assistant devices 107 is executed.

Thereafter, the program is returned to the processing waiting loop again. On the other hand, in the step S305, if there is no timing for sending the advertisement information, in a step S307, processing for sending other data is executed.

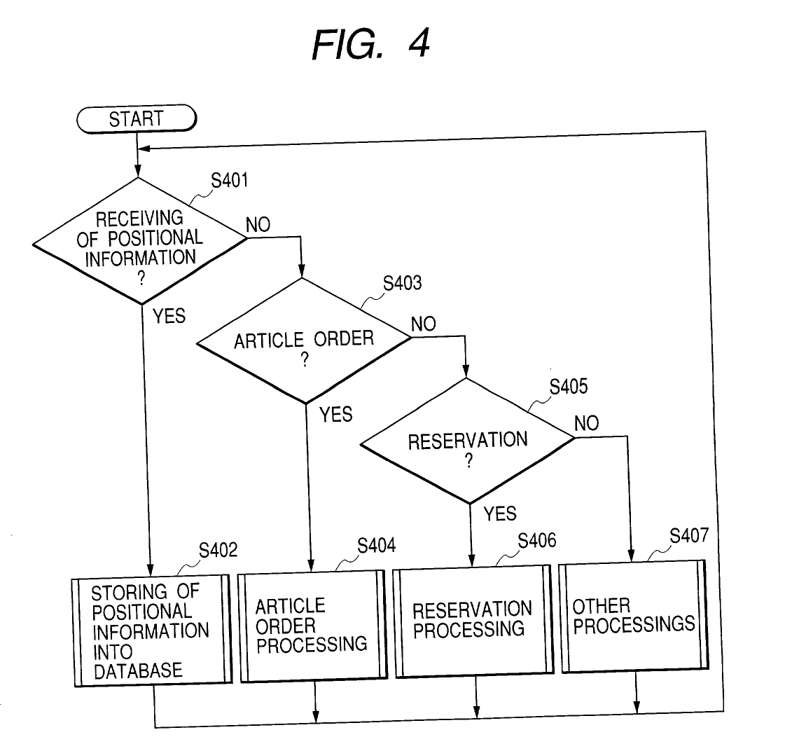

FIG. 4 is a flow chart for explaining a processing procedure executed with respect to received data from the personal digital assistant device 107, in processing of the server system 101.

In FIG. 4, in a step S401, processing for checking whether there is positional information data is executed. The positional information data is data returned from the personal digital assistant device 107 in response to the positional information request data sent from the server system 101 in the step S302 in FIG. 3.

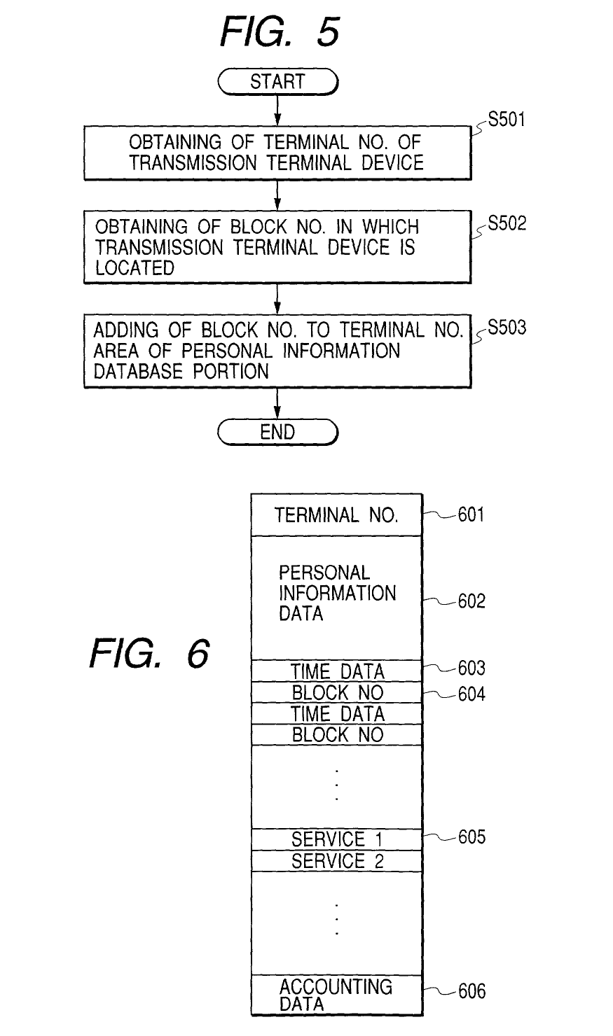

If there is the positional information data, in a step S402, processing for adding the received positional information data to the position history data in the personal information database portion 104 of the server system 101 is executed. The details of such processing will be fully described with reference to FIG. 5. Thereafter, the program is returned to the processing waiting loop again.

Further, in a step S403, processing for checking whether there is order data for an article to be purchased is executed. As the article order, a method in which the article is ordered in response to the article information sent in the step S304 in FIG. 3, a method in which the article is selected from catalogue data previously stored in the personal digital assistant device 107 and the selected article is ordered or a method in which an article number of an article which was actually checked by the user at a shop is inputted to the personal digital assistant device 107 to order such an article is considered.

If there is the article order data, in a step S404, article order processing is executed, and the order data is added to the personal information database portion 104 of the server system 101 and accounting processing is executed. Thereafter, the program is returned to the processing waiting loop again.

Further, in a step S405, processing for checking whether there is reservation request data is executed. For example, the object of reservation is entry into event, rental of equipment and the like.

If there is the reservation request data, in a step S406, the requested reservation processing, i.e., processing for informing of reservation to an owner or manager of a shop as the object of reservation or an event organizer and, at the same time, for adding reservation data to the personal information database portion 104 of the server system 101 is executed. Thereafter, the program is returned to the processing waiting loop again. On the other hand, if there is no reservation request data in the step S405, in a step S407 processing for other data is executed.

Since the server system 101 is a multi-task system capable of performing plural processing operations simultaneously, the processing for actively sending the data to the personal digital assistant device 107 as described in connection with FIG. 3 and the processing performed with respect to the data received from the personal assistant device 107 as described in connection with FIG. 4 are executed in parallel in the main processing flow of the server system 101. Of course, regarding other processing operations, parallel is performed in accordance with execution requests.

FIG. 5 is a flow chart showing the details of the processing for adding the received positional information data to the personal information database portion 104 of the server system 101, executed in the step S402 in FIG. 4. The received positional information data may include data such as a terminal number of the personal digital assistant device 107 from which the data was sent, a block number of the place where the personal digital assistant device 107 was located when the data was sent, a data sending time and the like. The block number means that minimum division units of an area which can be detected by using the radio communication system are designated by respective blocks and the respective blocks are indicated by unique through numbers.

In FIG. 5, first of all, in a step S501, processing for acquiring the terminal number of the personal digital assistant device 107 from which the positional information data was sent on the basis of the sending data is executed. Then, in a step S502, processing for acquiring the block number of the block where the personal digital assistant device 107 is located is executed. Lastly, in a step S503, position history data is produced by executing processing for adding the block number acquired in the step S502 to an area corresponding to the terminal number acquired in the step S501, in the personal information database portion 104 of the server system 101.

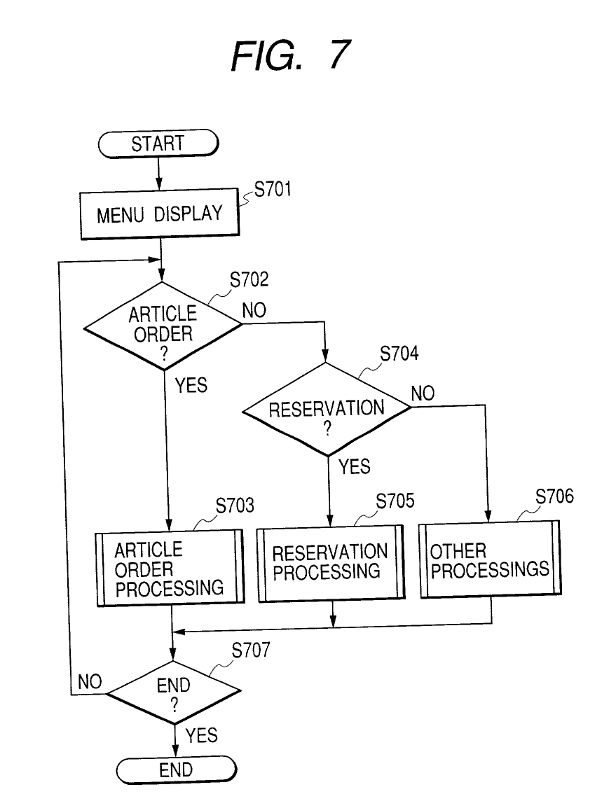

FIG. 6 is a view showing an example of a data structure of the personal information data for a certain personal digital assistant device 107 in the personal information database portion 104 of the server system 101.

In FIG. 6, the reference numeral 601 denotes an area in which the terminal number is stored. The terminal numbers are unique numbers previously shared or allotted to the respective personal digital assistant devices 107 and are written in the flash memories in the storage portions 202 of the respective personal digital assistant devices 107.

When the data is sent from the personal digital assistant device 107 to the server system 101, the data with the terminal number is sent in order that the server system 101 can recognize the terminal from which the data was sent.

The reference numeral 602 denotes an area in which the personal information data is stored. The personal information data is basic information regarding the user of the personal digital assistant device 107, including user's name, address, age and sex distinction. Such personal information data is inputted when the user borrows the personal digital assistant device 107.

The reference numerals 603 and 604 denote areas in which history data as positional information detecting result are stored, where detection time is stored in the area 603 and the block number is stored in the area 604. Such data are stored by the processing explained in connection with the step S402 in FIG. 4 and are added periodically whenever the positional information detecting processing is executed.

The reference numeral 605 denotes an area in which histories of various services presented by the server system 101 are stored. Such services include the article order processing explained in connection with the step S404 in FIG. 4, the reservation processing as explained in connection with the step S406 and the like, data representing the contents of the service is added whenever the service is presented.

The reference numeral 606 denotes an area in which accounting data is stored. In this area, a sum of charges to be paid and detailed data thereof (such as prices for various services and rental fee of the personal digital assistant device 107) are stored.

Next, explanation will be continued with reference to a flow chart of FIG. 7 for explaining a processing procedure for requesting the service to the server system 101, in the processing of the personal digital assistant device 107.

In FIG. 7, first of all, in a step S701, a menu screen indicating the contents of services is displayed on the display portion 203 of the personal digital assistant device 107. The contents of various services such as article order, reservation and the like are displayed in the menu by characters, and the user can select the service in the menu by manipulating the control key portion 204 of the personal digital assistant device 107.

In a step S702, if the article order service is selected, in a step S703, the article order processing is executed. In the article order processing, the article is selected by using a method for selecting the article in response to the article information sent from the server system 101 in the step S304 of FIG. 3, a method for selecting the article from the catalogue data previously stored in the personal digital assistant device 107 or a method for directly inputting the article number of the article which was actually checked in the shop from the personal digital assistant device 107, and the article order request data is sent to the server system 101.

The server system 101 receives the article order request data and executes the article order processing explained in connection with the step S404 in FIG. 4. When the article order processing is finished, in a step S707, it is ascertained whether service request processing is to be ended or not; if such processing is to be ended, the program is ended. On the other hand, if such processing is continued, the program is returned to the menu display processing in the step S701 again.

On the other hand, if the article order service is not selected in the step S702, in a step S704, it is checked whether the reservation service is selected or not; if the reservation service is selected, in a step S705, the reservation processing is executed.

In the reservation processing, the object of the reservation includes, for example, entry into restraint or event and rental of equipment, and, in this reservation processing, determination of the reservation is effected by using a method for selecting contents of the reservation in response to the article information sent from the server system 101 in the step S304 of FIG. 3, a method for selecting contents of the reservation from reservation list data previously stored in the personal digital assistant device 107 or a method for directly inputting a number of a reservation item which was ascertained at the actually effected place from the personal digital assistant device 107, and reservation request data is sent to the server system 101.

The server system 101 receives the reservation request data and executes the reservation processing shown in the step S406 of FIG. 4. When the reservation processing is finished, in a step S707, it is ascertained whether the service request processing is to be ended or not. If the processing is to be ended, the program is ended. On the other hand, if such processing is continued, the program is returned to the menu display processing in the step S701 again.

Further, in the step S704, if the reservation service is not selected, in a step S706, processing for other service is executed, and, thereafter, the program goes to the end checking processing in the step S707.

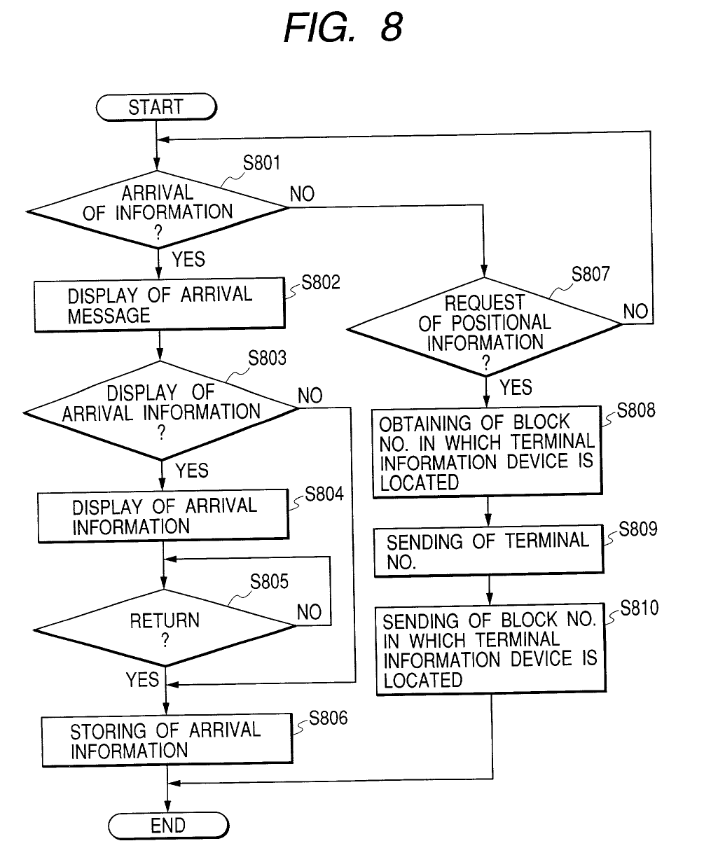

Next, a processing procedure executed when the data sent from the server system 101 in the processing of the personal digital assistant device 107 will be explained with reference to a flow chart shown in FIG. 8. Since the data from the server system 101 is sent irregularly, if other processing is being executed in the personal digital assistant device 107, such a processing procedure is effected as interruption processing.

In FIG. 8, first of all, in a step S801, it is checked whether the data sent from the server system 101 is information such as article information or information regarding advertisement, time service or event or not. Such information is data sent from the server system 101 in the sequence explained in connection with the steps S304, S306 of FIG. 3.

If the received data is such information, in a step S802, interruption processing is executed to display a message indicating arrival of information on the display portion 203 of the personal digital assistant device 107.

In a step S803, when the operator instructs display of the arrival information, in a step S804, the arrival information is displayed the display portion 203 of the personal digital assistant device 107.

Then, in a step S805, the program is waiting until instruction for returning the program to the processing which was being executed before the arrival of the information is given. If the instruction is given, in a step S806, processing for storing the arrival information in the flash memory is the storing portion 202 of the personal digital assistant device 107.

On the other hand, in the step S803, when the operator instructs that the arrival information is not displayed, the arrival information displaying processing in the step S804 is not effected and the program goes to the arrival information storing process in the step S806.

On the other hand, in the step S801, if the data sent from the server system 101 is not such information, in a step S807, it is checked whether such data is data representing the positional information request or not. The positional information request data is data sent by the sequence explained in connection with the step S302 of FIG. 3.

If the data is the positional information request data, in a step S808, processing for detecting the positional information, i.e., processing for acquiring the block number of the block where the personal digital assistant device 107 is presently located is executed. As explained in connection with FIG. 6, the block number is the unique number allotted to the minimum division unit of the area.

Then, in a step S809, the processing for sending the terminal number to the server system 101 is executed, and then, in a step S810, processing for sending the acquired block number is executed, and the program is ended.

Since the positional information request data from the server system 101 is sent periodically at a certain time interval, the processing operations explained in connection with the steps S808-S810 are effected in the back ground not to stop other processing operations.

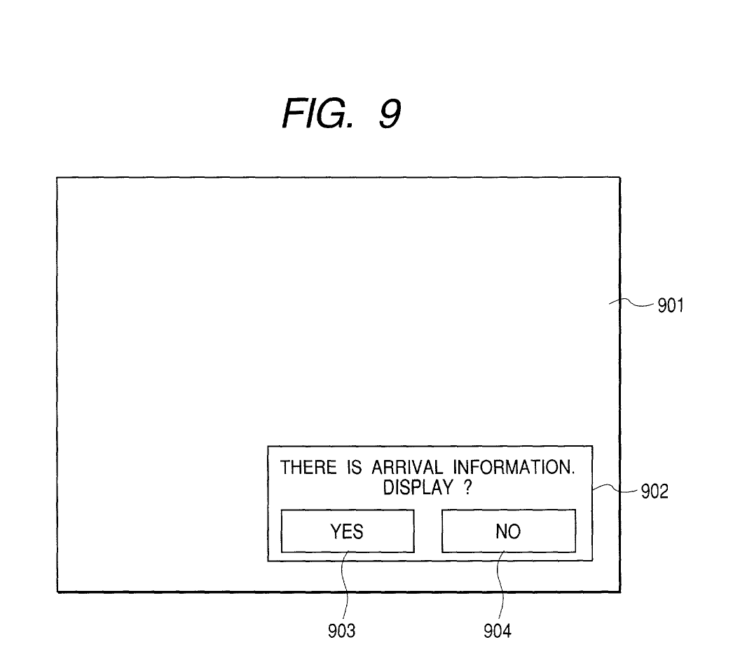

FIG. 9 shows an example of a display screen for the message displayed on the display portion 203 when the various informations are received by the personal digital assistant device 107 as explained in connection with the step S802 of FIG. 8.

In FIG. 9, the reference numeral 901 denotes a screen area when the display processing is being executed in the processing which has already been executed upon receipt of the message; and 902 denotes a screen area for message display representing the presence of the arrival information, which screen is displayed when the information is received. The message display is displayed on the already displayed screen in an overlapped relationship by the interruption processing.

Further, the reference numeral 903 denotes “Yes” icon for selecting whether the arrival information is displayed or not; and 904 similarly denotes “No” icon. By designating either one of the icons through the control key 204 of the personal digital assistant device 107, the instruction for displaying or not displaying the arrival information is possible.

<Second Embodiment>

In the first embodiment, in the system in which the personal digital assistant devices 107 and the server system 101 are incorporated into the local area PHS network only effective to the specific area and the distribution of information, and the request and execution of the service are effected, and the positional information of the personal digital assistant device is associated with the database, while an example that the present invention is carried out in the place where articles are mainly sold and bought, such as the department store and the shopping center was explained, the present invention is not limited to such an example.

In a second embodiment of the present invention, in a similar system, an application example in which the present invention is carried out in a place (such as a theme part, an exhibition ground, a recreation ground and the like) where many visitors gather and various events and/or attractions and various services associated therewith are effected will be fully explained.

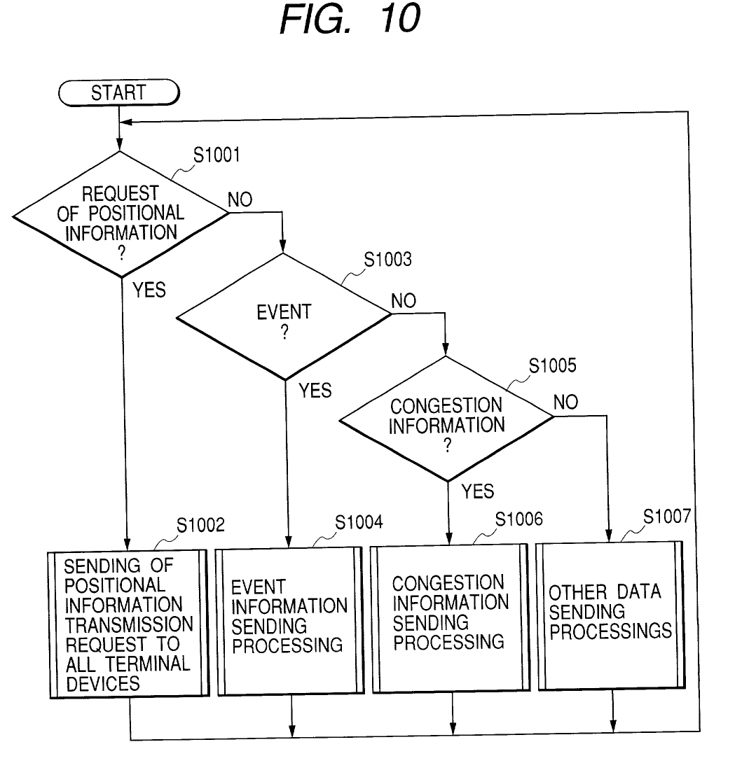

Now, a control processing procedures according to the second embodiment of the present invention will be explained with reference to flow charts of FIG. 10 and so on.

FIG. 10 is a flow chart for explaining a processing procedure for actively sending data to the personal digital assistant device 107 in processing of the server system 101.

In FIG. 10, in a step S1001, processing for checking whether there is a timing for requesting the positional information is effected. Similar to the step S301 of FIG. 3, the requesting of positional information is executed periodically with respect to the personal assistant device 107.

Here, if there is the timing for requesting the positional information, in a step S1002, similar to the step S302, in order acquire the positional information of the personal digital assistant device 107 used in the ground, sending request data regarding positional information is sent to all of the personal digital assistant devices 107.

Then, the program is returned to a processing waiting loop again. Further, in a step S1003, processing for checking whether there is a timing for sending guidance of events performed in the ground and information associated therewith is executed.

As the timing for sending the event information, similar to FIG. 3, for example, a case where information regarding performed on the basis of predefined schedules is sent at a previously programmed timing or a case where such information is sent irregularly by manipulating the server system 101 by the operator in accordance with circumstances is considered.

If there is the timing for sending the event information, in a step S1004, processing for sending the information regarding the events to all of the personal digital assistant devices 107 is executed. Then the program is returned to the processing waiting loop again.

Further, in a step S1005, processing for checking whether there is a timing for sending congestion information. The congestion information is information obtained by totalizing the positional information received from the personal digital assistant devices 107 and by calculating congestion degree at a specific point and is data representing congestion conditions of event places, restraints and/or attractions.

A method for calculating the congestion information will be fully described later. Here, if there is the timing for sending the congestion information, in a step S1006, processing for sending the congestion information to all of the personal digital assistant devices 107 is executed. Thereafter, the program is returned to the processing waiting loop again. In the step S1005, if there is no timing for sending the congestion information in a step S1007, processing for sending other data is executed.

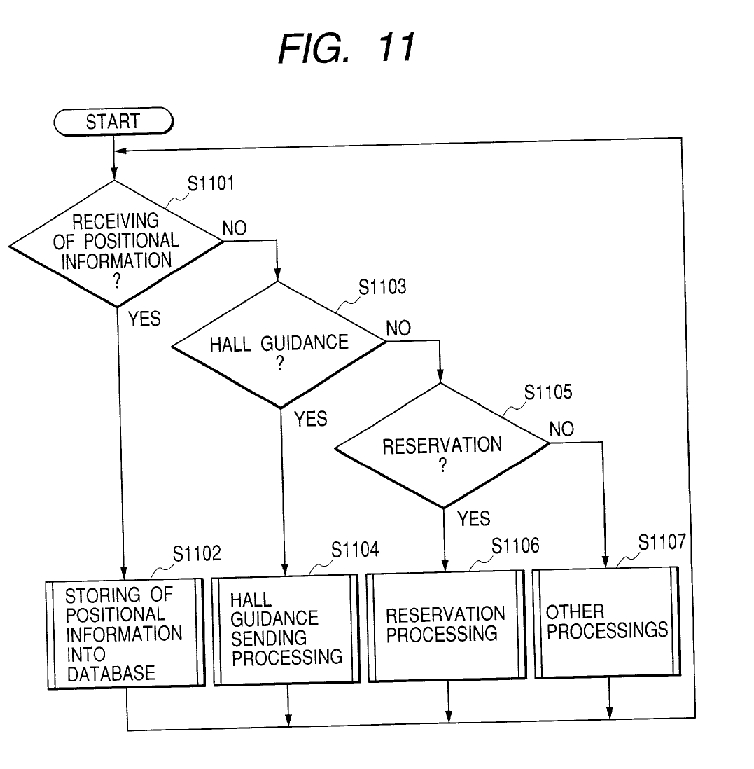

FIG. 11 is a flow chart for explaining a processing procedure executed with respect to the received data from the personal digital assistant device 107, in the processing of the server system 101.

In FIG. 11, in a step S1101, processing for checking whether there is positional information data is executed. The positional information data is data returned from the personal digital assistant device 107 in response to the positional information request data sent from the server system 101 in the step S1002 in FIG. 10.

If there is the positional information data, in a step S1102, processing for adding the received positional information data to the personal information database portion 104 of the server system 101 is executed. The details of such processing is similar to the contents explained in connection with FIG. 5. Thereafter, the program is returned to the processing waiting loop again.

Further, in a step S1103, processing for checking whether there is hall guidance request data is executed. The hall guidance is general fixed information regarding the hall, such as a map of the hall, guidance of institutions, schedule of the event and/or charge guidance.

If there is the hall guidance request data, in a step S1104, processing for sending the hall guidance data to the personal digital assistant device 107 emitting the request is executed. Thereafter, the program is returned to the processing waiting loop again. Further, in a step S1105, processing for checking whether there is reservation request data is executed.

Similar to FIG. 4, the object of reservation is entry into restraint or event, rental of equipment and the like. If there is the reservation request data, in a step S1106, the requested reservation processing, i.e., processing for informing of reservation to an owner or manager of a shop as the object of reservation or an even organizer and, at the same time, for adding reservation data to the personal information database portion 104 of the server system 101 is executed. Thereafter, the program is returned to the processing waiting loop again. On the other hand, if there is no reservation request data in the step S1105, in a step S1107, processing for sending other data is executed.

Also, in the second embodiment, since the server system 101 is a multi-task system capable of performing plural processing operations simultaneously, the processing for actively sending the data to the personal digital assistant device 107 as described in connection with FIG. 10 and the processing performed with respect to the data received from the personal digital assistant device 107 as described in connection with FIG. 11 are executed in parallel in the main processing flow of the server system 101. Of course, regarding other processing operations, parallel processing is performed in accordance with execution requests.

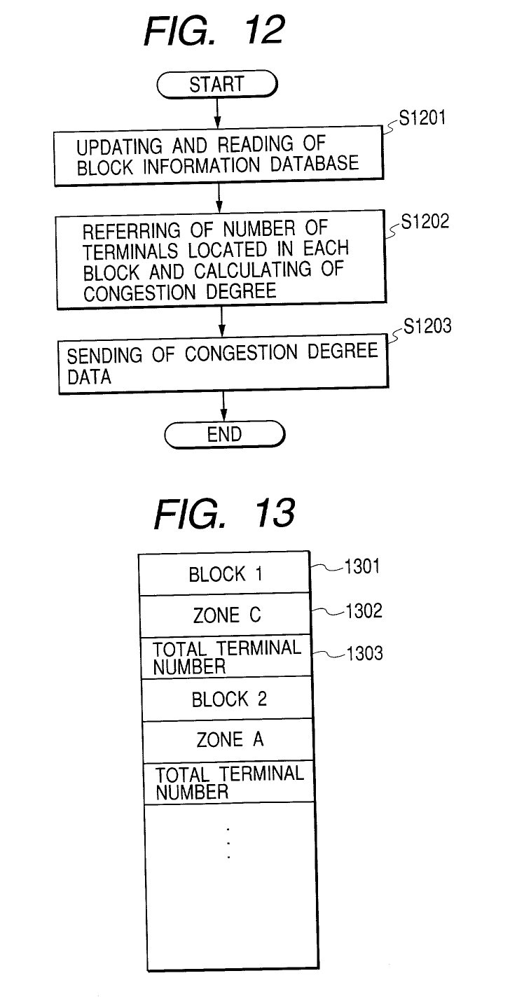

FIG. 12 is a flow chart showing the details of the congestion information calculating and sending processing executed in the step S1006 in FIG. 10.

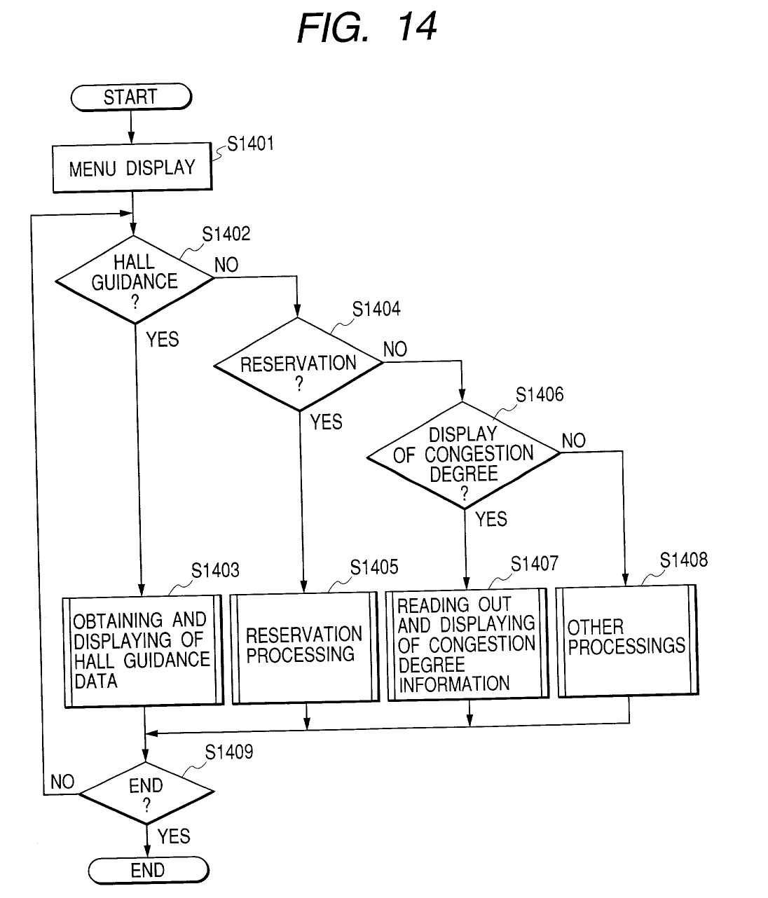

In FIG. 12, in a step S1201, processing for updating and reading a block information database is executed. The block information database is a database in which the blocks detected by the positional information detection processing and the number of the personal digital assistant devices 107 located in the blocks are stored in pairs, and a data structure thereof will be fully described in connection with FIG. 13.

In the database updating processing, processing for reconstructing the block information database to a latent condition on the basis of the history data (FIG. 6) regarding the positional informations of the personal digital assistant devices 107 produced in the step S402 of FIG. 4 and the step S1102 of FIG. 11 is executed. When the processing for updating and reading the block information database is finished, in a step S1202, processing for calculating the congestion degree of each block is executed with reference to the updated block information database.

In the calculation of the congestion degree, places providing the congestion information in the halls, such as restraints, event halls and entrances of attractions are assumed to be discrete zones, and processing for calculating the total number of personal digital assistant devices 107 by adding the number of the personal digital assistant devices 107 located in respective blocks with respect to all of the blocks included in the zones is executed, and processing for replacing the total number of the personal digital assistant devices 107 by ten-step numerical data is executed.

Namely, regarding a relationship between the block and the zone, the block is a unit representing a minimum area from which the positional information can be detected and the zone is a unit representing an area from which the congestion information is calculated, and each zone is constituted by concurrence of plural blocks. Then, in a step S1203, processing for sending a result obtained by executing the calculation of the congestion degree value with respect to all of zones is executed.

Further, the sent data include text data such as zone names (for example, “concert hall”, “restraint A” and the like), as well as zone numbers and congestion degree values.

FIG. 13 is a view showing a data structure of the block information database updated in the step S1201 of FIG. 12.

In FIG. 13, the reference numeral 1301 denotes an area in which the block number of block 1 is stored. Further, the reference numeral 1302 denotes an area in which a zone number of the zone including the block 1 is stored.

The reference numeral 1303 denotes an area in which the total number of the personal digital assistant devices 107 located in the block 1 is stored, and such number is calculated on the basis of the history data (FIG. 6) of the positional information for each personal digital assistant device 107. Similarly, regarding all of blocks such as a block 2, a block 3 and so on, similar data are successively stored.

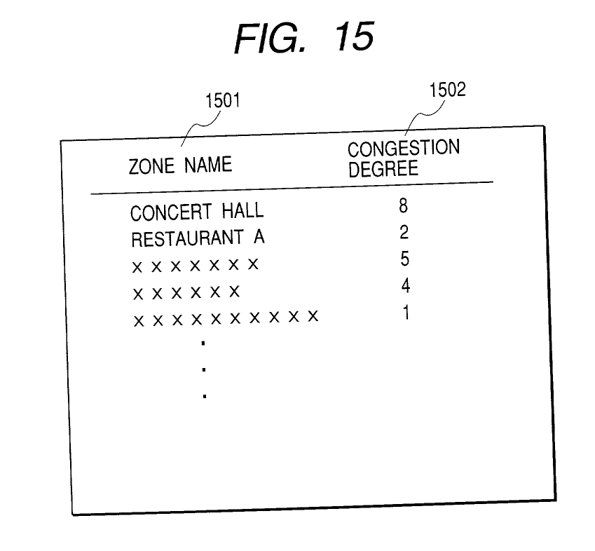

Next, a processing procedure for requesting the service to the server system 101 in the processing of the personal digital assistant device 107 according to the second embodiment of the present invention will be explained with reference to a flow chart shown in FIG. 14.

In FIG. 14, first of all, in a step S1401, a menu screen indicating the contents of services is displayed on the display portion 203 of the personal digital assistant device 107. The contents of various services such as hall guidance, reservation, inquiry of congestion degree and the like are displayed in the menu by characters, and the user can select the service in the menu by manipulating the control key portion 204 of the personal digital assistant device 107.

In a step S1402, if the hall guidance is selected, in a step S1403, processing for acquiring hall guidance information from the server system 101 and processing for displaying the acquired information on the display portion 203 of the personal digital assistant device 107 are executed. In the hall guidance acquiring processing, first of all, data for requesting the hall guidance information is sent to the server system 101, and the server system 101 receives such information and returns the hall guidance information in accordance with the sequence explained in connection with the step S1104 of FIG. 11.

As explained in connection with FIG. 11, the hall guidance data is general fixed information regarding the hall, such as a map of the hall, such as a map of the hall, guidance of institutions, schedule of the event and/or charge guidance. When the hall guidance information display processing is finished, in a step S1409, it is ascertained whether service request processing is to be finished or not; if such processing is to be finished, the program is ended. On the other hand, if such processing is continued, the program is returned to the menu display processing in the step S1401 again.

On the other hand, if the hall guidance is not selected in the step S1402, in a step S1404, it is checked whether the reservation service is selected or not; if the reservation service is selected, in a step S1405, the reservation processing is executed.

Similar to the explanation regarding FIG. 7, in the reservation processing, the object of the reservation includes, for example, entry into restraint or event and rental of equipment, and, in this reservation processing, determination of the reservation is effected by using a method for selecting contents of the reservation in response to the hall guidance acquired in the step S1403 and the event information sent from the server system 101 in the step S1004 of FIG. 10, a method for selecting contents of the reservation from reservation list data previously stored in the personal digital assistant device 107 or a method for directly inputting a number of a reservation item which was ascertained at the actually effected place from the personal digital assistant device 107, and reservation request data is sent to the server system 101.

The server system 101 receives the reservation request data and executes the reservation processing shown in the step S1106 of FIG. 11. When the reservation processing is finished, in a step S1409, it is ascertained whether the service request processing is to be ended or not. If the processing is to be ended, the program is ended. On the other hand, if such processing is continued, the program is returned to the menu display processing in the step S1401 again.

Further, in the step S1404, if the reservation service is not selected, in a step S1406, it is checked whether the congestion degree information display processing is executed or not. If the display of the congestion degree information is selected, in a step S1407, the congestion degree information is read out from the storing portion 202 of the personal digital assistant device 107, and processing for displaying the read information on the display portion 203 is executed (refer to FIG. 15).

The congestion degree information is data sent from the server system 101 periodically in the step S1006 of FIG. 10, and when the personal digital assistant device 107 receives such data, such data is stored in the storing portion 202 of the personal digital assistant device 107.

When the congestion degree information display processing is finished, in the step S1409, it is ascertained whether service request processing is to be finished or not; if such processing is to be finished, the program is ended. On the other hand, if such processing is continued, the program is returned to the menu display processing in the step S1401 again.

On the other hand, if the display of the congestion degree is not selected in the step S1406, in a step S1408, processing for other service is executed, and, thereafter, the program goes to the end checking processing in the step S1409.

FIG. 15 shows an example of a display screen for the congestion degree information displayed on the display portion 203 of the personal digital assistant device 107 in the step S1407 of FIG. 14.

In FIG. 15, the reference numeral 1501 denotes an area in which the names of the places (zones) as the object of the congestion degree information are displayed; and 1502 denotes an area in which the congestion degree values of the respective zones are displayed.

The names of the zones displayed in the area 1501 are names of places such as “concert hall”, “restraint A” and the like corresponding to the zone numbers, and such name data are included in the congestion degree information data sent from the server system 101 in the step S1006 of FIG. 10.

In the second embodiment, the application example in which the personal digital assistant devices 107 and the server system 101 are used in a place (such as a theme park, an exhibition ground, a recreation ground and the like) where many visitors gather and various events and/or attractions and various services associated therewith are effected was explained.

Various informations such as positional information, service request and the like are sent from the personal assistant devices 107 to the server system 101, and these data are stored as the database in the personal information database portion 104 of FIG. 1 in the form of the data structure shown in FIG. 6.

Accordingly, since taste and moving path of each visitor can be grasped by checking the stored data, the organizer can provide service of fine texture to each visitor. Further, by totalizing these data in another way, such data can be reflected to management of the halls/grounds. For example, by totalizing the data timely and by comparing the totalized result with predetermined condition values, when the condition values are satisfied, corresponding distribution data may be selected automatically and be distributed to the personal digital assistant device.

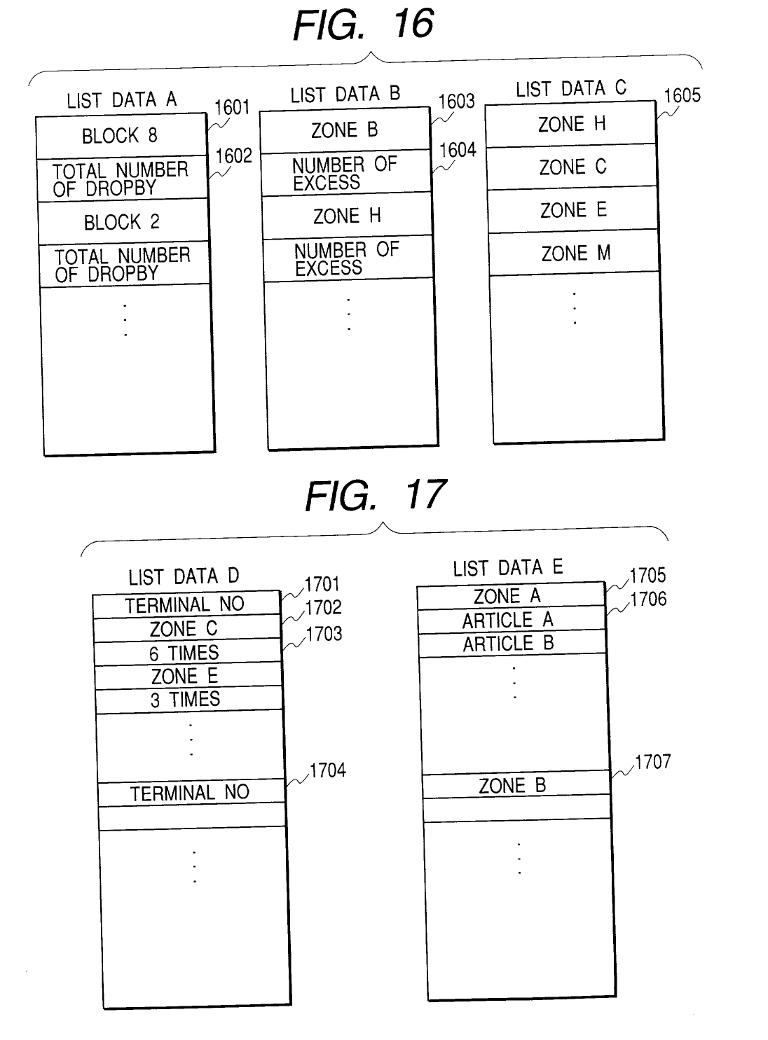

Next, FIG. 16 showing a data structure of the totalized database will be explained with reference to the personal database shown in FIG. 6.

In FIG. 16, list data A is a list representing the blocks in order from greater total number of dropby to smallest total number.

Namely, in this list, the number of the personal digital assistant devices is determined for each block by reading block numbers regarding all data from the personal database of FIG. 6 and by totalizing the number of the personal digital assistant devices 107 included in the block for each block number, and the blocks are arranged in order from greatest number of the personal digital assistant devices to smallest number of the personal digital assistant devices.

In the list data A, the reference numeral 1601 denotes an area in which the block number is stored; and 1602 denotes an area in which the total number of dropby, i.e., data representing the number that the personal digital assistant devices 107 are located is stored. Similarly, the data are stored in order from the block having the greatest total number of dropby to the block having the smallest total number of dropby.

Further, in the list data A, while the list in which the number that the personal digital assistant devices 107 are located is totalized for the block was represented, the zones represented by concurrence of the blocks may be totalized in the similar manner.

List data B is a list representing the zones into which visitors exceeding a predefined number enter. In this list, maximum values of visitors who can enter into respective zones are previously set, and it is counted how many times that the visitors (personal digital assistant devices 107) exceeding the maximum value enter, and the zones are arranged in order from the greatest exceeding times to the smallest exceeding times.

In the list data B, the reference numeral 1603 denotes an area in which the zone number is stored; and 1604 denotes an area in which the number of times that the number of entering visitors exceeds the preset value. Similarly, the data are stored in order from the zone having the greatest exceeding times to the zone having the smallest exceeding times.

List data C is a list representing the zones where the visitors not exceeding the pre-set value always enter. This is list data for storing the zones where the number of visitors (personal digital assistant devices 107) does not always exceed the pre-set value. In the list data C, the reference numeral 1605 denotes an area in which the zone number is stored. Similarly, the zone numbers of the zones which do not satisfy this condition are stored.

Further, by effecting the totalization with reference to the personal database shown in FIG. 6, various lists can be produced, other than the list data A, list data B and list data C. Further, by utilizing the time data 603 and the block data 604 stored in the personal data, a list for analyzing a moving trace of the personal digital assistant device 107 can be produced.

For example, a list representing the number of the personal digital assistant devices 107 which have fast moving speed or slow moving speed, and a list representing the zones in which increase/decrease of the number of the personal digital assistant devices 107 per unit time is great or small are considered. Further, by utilizing the service history data 605 stored in the personal data, a list representing the services having much requests can be produced.

Such total processing and list producing processing may be executed periodically at a predetermined timing in the total processing portion 105 of the server system 101 or may be executed after the service processing is stopped after the halls/grounds are closed. Further, the total processing is executed in parallel in the back ground without stopping other processing operations.

<Third Embodiment>

In the second embodiment, the embodiment in which all of the informations actively sent from the server system 101 are processed with respect to all of the personal digital assistant devices 107 was explained.

For example, such processing operations are the processing for sending the article information in the step S304 of FIG. 3 and the processing for sending the advertisement information in the step S305 in the first embodiment, and the processing for sending the event guidance in the step S1003 of FIG. 10 and the processing for sending the congestion information in the step S1005.

However, the present invention is not limited to such processing operations. If the number of the recipient personal digital assistant devices 107 is reduced more or less, the sending number will be decreased and burden of the server system 101 will be reduced, and the personal digital assistant device 107 will not receive useless information, thereby saving the flash memory for storing the informations.

In a third embodiment of the present invention, an embodiment in which, by producing a total list data by utilizing the personal database explained in connection with FIG. 6 and by referring to such list data, when the information is sent from the server system 101, the recipient personal digital assistant devices 107 are defined or limited will be explained.

Further, in the third embodiment, an application example in which the processing for sending the article information explained in connection with the step S304 of FIG. 3 is executed in a place (such as a department store, a shopping center and the like) where articles are mainly sold and bought as is in the first embodiment will be explained.

FIG. 17 is a view showing a data structure of a database obtained by effecting totalization with reference to the personal database shown in FIG. 6, according to the third embodiment.

In FIG. 17, list data D is a list representing zones having many number of dropby for each personal digital assistant device 107.

In this list, after the history data of the block number stored in the personal database of FIG. 6 for each personal assistant device 107 is read out, and the zone numbers of the zones including the respective blocks are calculated, and the times that the zone number is appeared are totalized, and the zone numbers are arranged in order from the greatest appearing times to the smallest appearing times.

In the list data D, the reference numeral 1701 denotes an area in which the terminal number is stored; 1702 denotes an area in which the zone number is stored; and 1703 denotes an area in which data regarding the times that the personal digital assistant device 107 drops by the zone stored in the area 1702 is stored.

Similarly, the zone numbers where that the personal digital assistant device 107 stored in the area 1701 drops by and the times thereof are stored in order from the greatest number of dropby to smallest number of dropby. Further, the reference numeral 1704 denotes an area in which the terminal number of the next personal digital assistant device 107 is stored. Similarly, as is in the areas 1702, 1703, data are stored in order from the greatest number of dropby to smallest number of dropby. List data E is a list representing correspondence between the respective zones and the articles handled in the zones.

In FIG. 17, the reference numeral 1705 denotes an area in which the zone number (zone A) is stored; and 1706 denotes an area in which data (for example, article numbers) representing the articles handled in the zone A are stored. In the area 1706, plural data representing the articles are stored.

The reference numeral 1707 denotes an area in which the zone number of the next zone (zone B) is stored, and then the article numbers regarding the zone B follow. Similarly, the zone numbers of all zones and the article numbers associated therewith the stored.

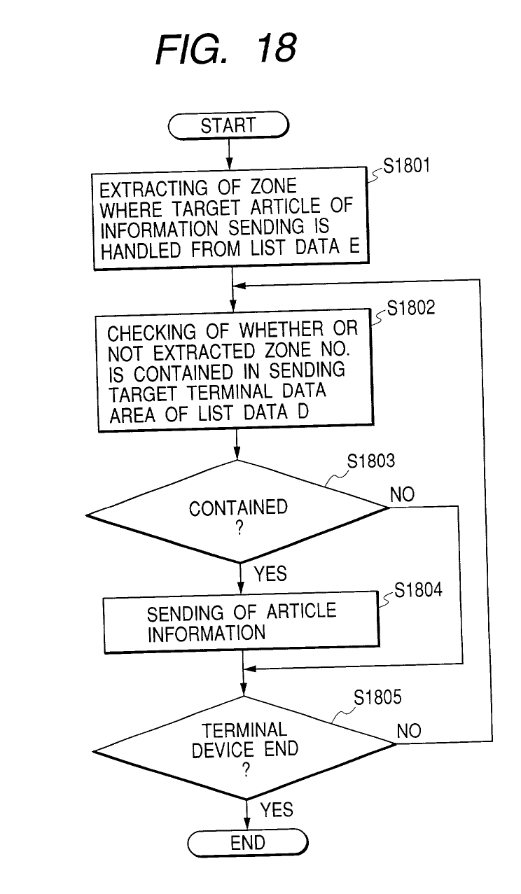

The server system 101 can send the information useful for the user of the personal digital assistant device 107 in a procedure or sequence (which will be described later in connection with FIG. 18) by referring to such two list data.

Next, FIG. 18 showing a flow chart for explaining the detailed procedure of the processing for sending the article information in the step S304 of FIG. 3, according to the third embodiment, will be explained.

In FIG. 18, in a step S1801, processing for extracting the zone number in which the article as the information sending target is handled from the list data E shown in FIG. 17 is executed.

Then, in a step S1802, processing for checking whether the zone number extracted in the step S1801 is contained in the area where the information of the personal digital assistant device 107 as the sending target by referring to the list data D of FIG. 17 is executed.

In a step S1803, if it is ascertained that the zone number is contained, in a step S1804, processing for sending the article information to the personal digital assistant device 107 checked in the step S1802 is executed, and then the program goes to a step S1805. On the other hand, if not contained, the program goes to the step S1805 while skipping the sending processing in the step S1804.

In the step S1805, it is checked whether such processing operations are carried out with respect to all of the personal digital assistant devices 107 or not. If the processing operations are carried out with respect to all of the personal digital assistant devices 107, the program is ended. On the other hand, if such processing operations are not yet ended with respect to all of the personal digital assistant devices 107, the program is returned to the processing in the step S1802, where the processing for checking the zone number with respect to the next personal digital assistant device 107 is executed.

While it was checked whether the zone number extracted from the list data E is contained in the list data D in the zone number checking processing of the step S1802, it should be noted that further limitation of the personal digital assistant device 107 as the information sending target can be realized by executing processing for checking whether the extracted zone number is contained in the list data D by times greater than predetermined times.

Incidentally, it should be noted that the third embodiment can be applied to not only the article information sending processing in the step S304 of FIG. 3 according to the first embodiment, but also the advertisement information sending processing in the step S305 of FIG. 3 according to the first embodiment, the event guidance sending processing in the step S1003 of FIG. 10 and the congestion information sending processing in the step S1005 according to the second embodiment, and other information sending processing operations in the similar processing procedure.

Further, in the illustrated embodiment, while an example that the positional information intermittently sent from the personal digital assistant device is stored in the database as the position history data and the taste of the user is judged on the basis of the history data to send the article information was explained, in the present invention, information of articles purchased by the user may also be stored as purchase history data and the article information may be selected and sent on the basis of the position history data and the purchase history data.

<Fourth Embodiment>

In the first and second embodiments, while an example that, as the service processing operations requested from the personal digital assistant device 107 and executed in the server system 101, the article order processing in the step S404 of FIG. 4, the reservation processing in the step S405 and the hall guidance processing in the step S1103 of FIG. 11 are listed was explained, the present invention is not limited to such an example.

In a fourth embodiment of the present invention, an embodiment of execution of a service for searching the personal digital assistant device 107 to communicate with a position where the personal digital assistant device 107 is presently located, by utilizing a positional information detecting function will be explained.

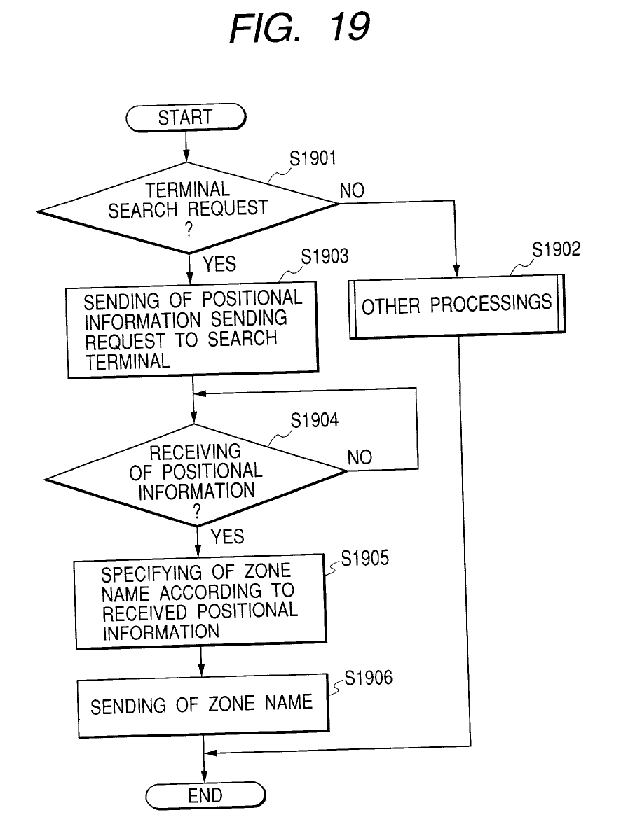

FIG. 19 is a flow chart for fully explaining contents of processing included in other processing operations in the step S407 among the processing operations executed by the server system 101 with respect to the received data from the personal digital assistant device 107 in the fourth embodiment of the present invention.

In FIG. 19, in a step S1901, it is checked whether a service for searching the personal digital assistant device 107 is requested or not. If the service for searching the personal digital assistant device 107 is not requested, in a step S1902, processing for other service is executed, and then the program is ended.

On the other hand, if the searching service is requested, in a step S1903, processing for sending data for requesting sending of the positional information regarding the present location of the personal digital assistant device 107 to the terminal as the searching target requested is executed. Then, in a step S1904, if data informing the positional information is received from the requested personal digital assistant device 107, in a step S1905, processing for acquiring the zone number containing the block number corresponding to the received positional information is executed, and then processing for obtaining the zone name from the acquired zone number is executed.

The processing for acquiring the zone number containing the block number can be executed by retrieving table data (previously provided in the server system 101) storing the block number and the zone number containing the block number.

Similarly, the processing for obtaining the zone name from the zone number can be realized by retrieving table data in which text data representing the zone number and the zone name in pair is stored.

After the zone name is determined, in a step S1906, processing for sending the text data representing the zone number and the zone name to the personal digital assistant device 107 from which the searching service is requested is executed, and then the service processing for searching the personal digital assistant device 107 is ended.

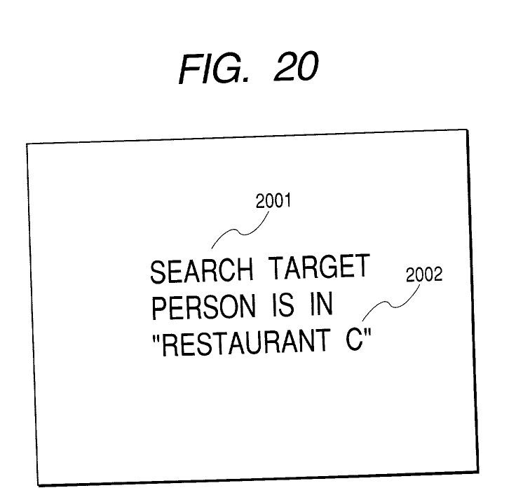

FIG. 20 shows an example of a screen displaying a search result on the display portion 203 of the personal digital assistant device 107 from which the searching service is requested.

In FIG. 20, the reference numeral 2001 denotes a message display area including the search result. Further, the reference numeral 2002 denotes a portion displaying “restraint C” as the zone name sent from the server system 101 as the search result.

Incidentally, it should be noted that the service processing for searching the personal digital assistant device 107 can be executed in other processing in the step S1107 of FIG. 11 according to the second embodiment and can be carried out in a place such as a theme park, an exhibition ground and a recreation ground.

Further, in the illustrated embodiment, while an example that the zone name as the search result is displayed on the display portion 203 as the text data was explained, it should be noted that map data may be displayed on the display by using the map data and the zone number sent from the server system 101, for example, by previously storing the map data of the grounds and the halls in the personal digital assistant device 107 and the position of the searched personal digital assistant device 107 may be displayed on the map screen in an overlapped fashion.

<Fifth Embodiment>

In the first to fourth embodiments, while an example that the personal digital assistant devices 107 and the server system 101 are incorporated into the local area PHS network only effective to the specific area and various services such as sending/receiving and reservation of the article and event and search of position are presented was explained, the present invention is not limited to such an example.

In the aforementioned embodiments, the server system 101 must be installed (for example, at a fixed position) within the PHS communication network, so that arrangement or installation of various equipments in the grounds and halls is limited. Further, the PHS communication unit must be mounted to the server system 101.

In a fifth embodiment of the present invention, an embodiment in which the server system 101 is installed out of the PHS communication network and a PHS communication interface device is provided in the PHS communication network and the personal digital assistant devices 107 effect communication with the communication interface device through PHS and data can be sent and received between the personal digital assistant device 107 and the image server system 101 by connecting the PHS communication interface device to the server system 101 through LAN will be explained.

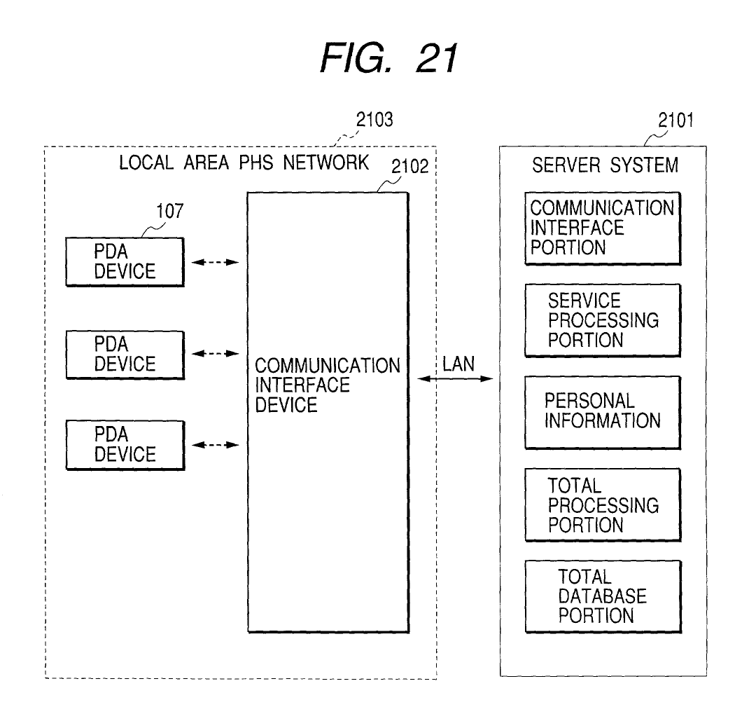

FIG. 21 is a block diagram showing a schematic construction including personal digital assistant devices 107 and a server system 2101 according to the fifth embodiment of the present invention.

In FIG. 21, the server system 2101 serves to accumulate and manage personal data and to present various services. Similar to the server system 101 shown in FIG. 1, the server system 2101 includes a communication interface portion, a server processing portion, a personal information database portion, a total processing portion and a total database portion and can be communicated with a communication interface device 2102.

The communication interface portion of the server system 2101 has a LAN interface and is connected to the communication interface device 2102 through LAN.

The communication interface device 2102 has a LAN interface. Further, the communication interface device also has a PHS interface and effects communication with the personal digital assistant devices 107 through local area PHS.

Accordingly, the communication interface device 2102 acts as an interface for sending data received from the personal digital assistant device 107 through PHS communication to the server system 2101 through LAN and for sending data received from the server system 2101 to the personal digital assistant device 107. Further, the personal digital assistant device 107 is similar to that explained in connection with FIG. 1.

The reference numeral 2103 indicates a range of the local area PHS network only effective to a specific area, and the communication interface device 2102 is fixedly installed within this range. Further, the personal digital assistant devices 107 are used within this range.

<Sixth Embodiment>

In the aforementioned first to fifth embodiments, while an example that the personal digital assistant devices 107 and the server system 101 (2101) are incorporated into the local area PHS network only effective to the specific area and the various devices and the system are arranged so that various services such as sending/receiving and reservation of the article and event and search of portion are presented was explained, the present invention is not limited to such an example.

In a sixth embodiment of the present invention, a management method for giving profits to both the visitors and the organizer by utilizing a system constituted by the personal digital assistant devices 107 and the server system 101 (2101) in a place which has a great ground area or floor and where many visitors gather, such as a recreation ground, an exhibition ground, a theme part, a hotel and a department store will be explained.

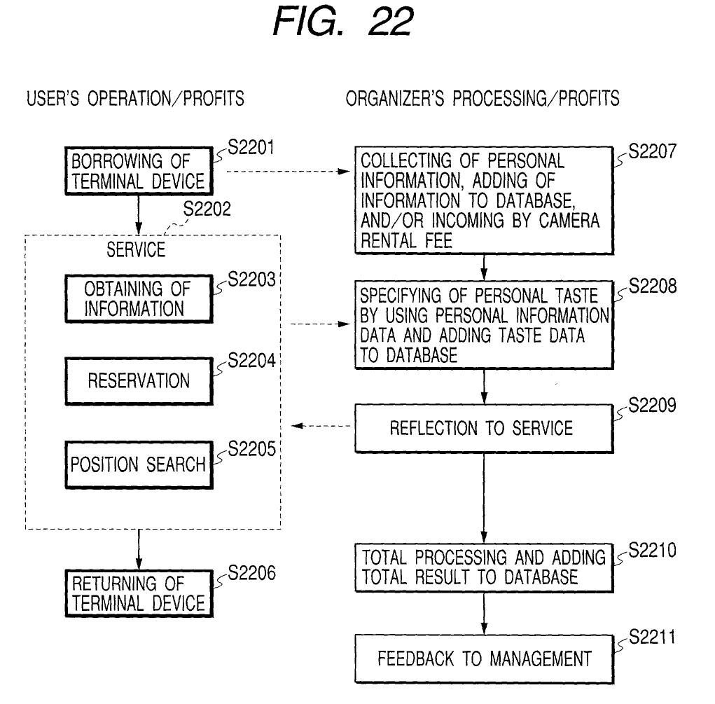

FIG. 22 is a view showing management of a system utilizing the personal digital assistant devices 107 and the server system 101 (2101) and illustrating user's operation/profits and organizer's processing/profits.

In FIG. 22, steps S2201, S2203, S2204, S2205 and S2206 represent user's operations, and steps S2207, S2208, S2209, S2210 and S2211 represent organizer's processing operation/profits.

First of all, the step S2201 represents an operation in which the user borrows the personal digital assistant device 107 at the entrance of a hall or ground. The personal digital assistant device 107 to be borrowed here is customized to facilitate the use of the device in the hall or ground, so that the user does not require to perform troublesome operation such as setting of the server system 101 (2101) as the recipient for receiving the data.

On the other hand, an operation for article order and/or reservation corresponding to various information sent from the server system 101 (2101) and sending/receiving of positional information can easily be carried out. The step S2207 represents processing operations of the server system 101 (2101) associated with the borrowing of the personal digital assistant device 107.

First of all, when the personal digital assistant device 107 is borrowed, as a procedure for certifying the borrower, since an identification card such as a driver license card must be presented to acquire information such as name, address, sex distinction and age, such information is stored in the personal information database portion 104 of the server system 101 (2101) Further, since rental charge is generated simultaneously, rental charge adding processing is executed, and charging data is also stored in the personal information database portion 104.

A step S2202 represents various services which can be presented in the hall or ground. Accordingly, after the user borrows the personal digital assistant device 107, in the hall or ground, various services presented from the server system 101 (2101) such as information acquiring service in the step S2203, reservation service in the step S2204, position search service in the step S2205 and the like can be utilized at any time. The details of the services are the same as those explained in connection with the first to fifth embodiments.

The step S2208 represents processing executed in the server system 101 (2101) when one or more services shown in the steps S2203-S2205 is presented to the user of the personal digital assistant device 107. Since the server system 101 (2101) can acquire the positional information of the personal digital assistant device 107 by which the service is presented upon presentation of the service, the server system executes processing for adding data regarding the place and moving trace in which the personal digital assistant device 107 drops by and history data of the presented service to the personal information database.

Accordingly, the server can obtain taste information of each user as data by referring to the place into which the user drops by and articles located in such a place and the service presented in such a place. Further, the step S2209 represents processing for reflecting to further services (for example, sending of only informations useful for the user) by utilizing the personal taste data (refer to the third embodiment; FIG. 18).

Further, processing for totalizing the informations collected in the steps S2210 and S2208 is executed, and the total data is added to the database. The total data is data representing the number and moving traces of the users at each place in the hall or ground (refer to the third embodiment; FIG. 16). On the basis of such total data, in the step S2211, processing for feeding-back to the hall management is executed.

Namely, on the basis of the total data, layout of the hall, arrangement of equipment and the contents of services can be looked at again, thereby reflecting to further management.

When the user of the personal digital assistant device 107 leaves the hall or ground, as shown in the step S2206, the borrowed personal digital assistant device is returned.

Here, the charges for the purchase of article(s) and service(s) in the hall or ground and stored in the charging data area of the personal information database portion of the server system 101 (2101) are cleared off, and the user pays the total charge.

<Other Embodiments>

In the present invention, on the assumption that accuracy of positional information detection using the radio communication function is excellent, the blocks as unit representing the minimum area capable of detecting the positional information, and the congestion information were calculated. Further, while an example that the data are managed by using two groups of the zones each of which is unit representing partition suitable for a management style of the hall or ground was explained, the present invention is not limited to such an example, it should be noted that, if radio communication means having worse accuracy of positional information detection and capable of detecting only a relatively wide area is used, areas which can be detected may be utilized as zones as they are.

Further, in the first, second, fourth and fifth embodiments, while an example that the local area PHS system is used as the radio communication means and position detection means was explained, the present invention is not limited to such an example. For example, it can easily be considered to adopt an embodiment in which other position detection means such as a GPS system is used.

Further, the radio communication means is not limited to the PHS system, but, it should be noted that similar effects can be achieved by using other radio communication means. Further, in the sixth embodiment, the management example in which charges for purchasing the article and/or obtaining the service in the hall or ground are recorded in the accounting area of the personal information database of the server system 101 (2101) and such charges are cleared off when the borrowed personal digital assistant device 107 is returned and the user pays the total charge was explained.

In this case, the user wants to always grasp total money to be presently paid. Accordingly, it is considered to adopt an embodiment of a personal digital assistant device 107 having application in which the personal digital assistant device 107 inquires of the server system 101 (2101) about the total charge and the server system 101 (2101) sends or returns the accounting data recording in the accounting area of the personal information database of the user having the inquiring personal digital assistant device 107 to such personal digital assistant device and the received total charge is displayed on the screen of the personal digital assistant device 107.

Regarding such application, for example, it is considered to adopt an embodiment in which the total charge to be paid for the services is displayed on the display portion by switching the mode of the personal digital assistant device 107 into a charge displaying mode or an embodiment in which the total charge is always displayed on a part of the display screen of the personal digital assistant device 107 without switching the mode even when any mode is used.

<Other Embodiments of the Present Invention>

Incidentally, the personal digital assistant device 107 and the server system 101 (2101) according to the aforementioned embodiments are constituted by CPU or MPU of a computer, RAM and/or ROM and are designed so that the functions can be realized by operating the programs stored in the RAM and ROM. Accordingly, they can be realized by recording a program for operating the computer to achieve the functions in a recording medium such as CD-ROM and by reading the program by means of the computer. As the recording medium for recording the program, for example, a floppy disk, a hard disk, a magnetic tape, a photo-magnetic disk or a non-volatile memory card, as well as the CD-ROM can be used.

Further, it should be noted that the present invention includes such a program when not only the functions of the above-mentioned embodiments are realized by executing the supplied program by means of the computer, but also the program cooperates with OS (operating system) running on the computer or other application software to realize the functions of the above-mentioned embodiments or processing of the supplied program is executed partially or totally by a function expansion board of the computer or a function expansion unit to realize the functions of the above-mentioned embodiments.

Further, the program may be carried out partially or totally by another computer to utilize the present invention under a network environment. For example, screen inputting processing may be executed by a remote terminal computer and various judging operations and log recording operations may be performed by another center computer and the like.

As mentioned above, according to the aforementioned embodiments, the user can timely know the informations charged successively as the time is lapsed, such as opening of event, time service and grasp of congestion condition. Thus, there can be provided a great advantage that the user can go around the halls and/or ground efficiently and buy the article intentionally.

Further, in the aforementioned embodiments, since the user of the personal digital assistant device can always grasp the place where his friend or partner exists, the missing (child) can be avoided even in the congestion condition, and, thus, particularly when a child or an aged person utilizes the personal digital assistant device or when the personal digital assistant device is utilized for waiting and meeting, a great effect can be achieved.

Further, by adopting a management method in which the personal digital assistant device customized to be suited for utilization in the hall can be borrowed, the user does not require to set the personal digital assistant device to be suited for the system in the hall or ground. Further, since the special procedure such as registration of the personal digital assistant device to the organizer or certification can be avoided when the service such as purchase or reservation of the article is presented, the user does not require to have special operation skill, and, thus, even a person who has little knowledge of machinery can use the personal digital assistant device easily and operably.

Furthermore, since not only the basic information of the user himself such as address, name, age and sex distinction is obtained in the procedure when the personal digital assistant device is borrowed, but also the positional information of the position where the device is located is obtained during the using of the personal digital assistant device in the hall or ground, by constituting these informations as database and by totalizing the information in accordance with the object, the taste information of the user using the personal digital assistant device regarding the article and the service can be obtained. By utilizing such information, the information to be sent to the user can be selected. Further, the contents of the services can be looked at again, thereby enhancing the quality of the service.

Further, since the moving trance of the personal digital assistant device can be known by the positional information acquiring function, the layout of the halls and grounds and arrangement of the equipment can be looked at again by analyzing the moving trace, thereby reflecting to further management. Thus, walking routes of persons in the grounds and places presenting various services can be improved efficiently, thereby providing convenient halls and grounds.

Further, by adopting the management method in which the charges for the service presented to the user of the personal digital assistant device and for the article bought by the user are stored in the server as the accounting data and such charges are cleared off when the personal digital assistant device is returned, the user does not pay the cash from his purse each time, thereby eliminating trouble.

What is claimed is:

1. A personal digital assistant device for receiving service information from a service information distribution device, comprising:
sending means for sending use information of a user using said personal digital assistant device intermittently to be added to a history database managed by said service information distribution device; and
receiving means for receiving the service information selected by said service information distribution device on the basis of history of the use information stored in said history database, from said service information distribution device.

2. A personal digital assistant device according to claim 1, wherein the use information includes positional information of said personal digital assistant device.

3. A personal digital assistant device according to claim 1, wherein said sending means sends use information requested by said service information distribution device to be sent.

4. A personal digital assistant device according to claim 1, further comprising display means for displaying the service information received by said receiving means.

5. A service information distribution device for distributing service information to a personal digital assistant device, comprising:
receiving means for receiving use information of a user intermittently from said personal digital assistant device;
storing means for storing the received use information in a history database as history data;
selection means for selecting service information to be distributed to said personal digital assistant device on the basis of the use information stored in said history database; and
distribution means for distributing the service information selected by said selection means to said personal digital assistant device.

6. A service information distribution device according to claim 5, wherein the use information includes positional information of said personal digital assistant device.

7. A service information distribution device according to claim 6, wherein said selection means selects service information regarding a zone by discriminating the zone having high frequency of dropby on the basis of the history data regarding the positional information.

8. A service information distribution device according to claim 5, wherein the service information includes congestion degree information.

9. A service information distribution device according to claim 5, wherein the service information includes at least one of informations regarding sale of an article, advertisement distribution, reservation, hall guidance, opening of an event and an attraction, suitable for said personal digital assistant device.

10. A service information distribution device according to claim 6, wherein said distribution means distributes the selected service information in response to request from said personal digital assistant device.

11. A service information distribution device according to claim 10, wherein said distribution means distributes selected positional information of another personal digital assistant device in response to request regarding positional information of said another personal digital assistant device from said personal digital assistant device.

12. A service information distribution device according to claim 5, wherein said history database also stores accounting information for the user.

13. A control method for controlling a personal digital assistant device for receiving service information from a service information distribution device, comprising:
a sending step for sending use information of a user using said personal digital assistant device intermittently to be added to a history database managed by said service information distribution device; and
a receiving step for receiving the service information selected by said service information distribution device on the basis of history of the use information stored in said history database, from said service information distribution device.

14. A control method according to claim 13, wherein the use information includes positional information of said personal digital assistant device.

15. A control method according to claim 13, wherein said sending step sends use information requested by said service information distribution device to be sent.

16. A control method according to claim 13, further comprising a displaying step for displaying the service information received by said receiving step.

17. A control method for controlling a service information distribution device for distributing service information to a personal digital assistant device, comprising:
a receiving step for receiving use information of a user intermittently from said personal digital assistant device;
a storing step for storing the received use information in a history database as history data;
a selecting step for selecting service information to be distributed to said personal digital assistant device on the basis of the use information stored in said history database; and
a distributing step for distributing the service information selected by said selecting step to said personal digital assistant device.

18. A control method according to claim 17, wherein the use information includes positional information of said personal digital assistant device.

19. A control method according to claim 18, wherein said selecting step selects service information regarding a zone by discriminating the zone having high frequency of dropby on the basis of the history data regarding the positional information.

20. A control method according to claim 17, wherein the service information includes congestion degree information.

21. A control method according to claim 17, wherein the service information includes at least one of informations regarding sale of an article, advertisement distribution, reservation, hall guidance, opening of an event and an attraction, suitable for said personal digital assistant device.

22. A control method according to claim 17, wherein said distributing step distributes the selected service information in response to request from said personal digital assistant device.

23. A control method according to claim 22, wherein said distributing step distributes selected positional information of another personal digital assistant device in response to request regarding positional information of said another personal digital assistant device from said personal digital assistant device.

24. A control method according to claim 17, wherein said history database also stores accounting information for the user.

25. A control program capable of being executed by a computer for controlling a personal digital assistant device for receiving service information from a service information distribution device, comprising:
a program code for executing a sending step for sending use information of a user using said personal digital assistant device intermittently to be added to a history database managed by said service information distribution device; and
a program code for executing a receiving step for receiving the service information selected by said service information distribution device on the basis of history of the use information stored in said history database, from said service information distribution device.

26. A control program capable of being executed by a computer for controlling a service information distribution device for distributing service information to a personal digital assistant device, comprising:
a program code executing a receiving step for receiving use information of a user intermittently from said personal digital assistant device;
a program code executing a storing step for storing the received use information in a history database as history data;
a program code for executing a selecting step for selecting service information to be distributed to said personal digital assistant device on the basis of the use information stored in said history database; and
a program code for executing a distributing step for distributing the service information selected by said selecting step to said personal digital assistant device.

27. A storing medium storing a control program capable of being read by a computer for controlling a personal digital assistant device for receiving service information from a service information distribution device, the control program comprising:
a program code for executing a sending step for sending use information of a user using said personal digital assistant device intermittently to be added to a history database managed by said service information distribution device; and
a program code for executing a receiving step for receiving the service information selected by said service information distribution device on the basis of history of the use information stored in said history database, from said service information distribution device.

28. A storing medium storing a control program capable of being read by a computer for controlling a service information distribution device for distributing service information to a personal digital assistant device, the control program comprising:
a program code for executing a receiving step for receiving use information of a user intermittently from said personal digital assistant device;
a program code for executing a storing step for storing the received use information in a history database as history data;
a program code for executing a selecting step for selecting service information to be distributed to said personal digital assistant device on the basis of the use information stored in said history database; and
a program code for executing a distributing step for distributing the service information selected by said selecting step to said personal digital assistant device.
